(19) United States
(12) Patent Application Publication
(10) Pub. No.: US 2025/0227183 A1
(43) Pub. Date: Jul. 10, 2025

(54) OUTPUT DEVICE FOR EACH PRINTER PAPER TRAY

(71) Applicant: Chun Ho CHON, Daejeon (KR)

(72) Inventor: Chun Ho CHON, Daejeon (KR)

(21) Appl. No.: 19/092,611

(22) Filed: Mar. 27, 2025

Related U.S. Application Data
(63) Continuation of application No. PCT/KR2022/012689, filed on Aug. 24, 2022.

(51) Int. Cl. H04N 1/00; G06F 3/12

(52) U.S. Cl. CPC H04N 1/00633; G06F 3/1205; G06F 3/1228

(57) ABSTRACT

Disclosed is an output device for each printer paper tray and, more specifically, to an output device for each printer paper tray, which enables a user to select new paper, scrap paper (green paper), or special paper suitably according to the use of a work to be output and easily print and output the work, thereby maximizing the effect of paper saving as well as the operability and usability of a printing device means by the user.

### TECHNICAL FIELD

The present invention relates to an output device for each printer paper tray and, more specifically, to an output device for each printer paper tray, which enables a user to select new paper, scrap paper (green paper), or special paper suitably according to the use of a work to be output and easily print and output the work, thereby maximizing the effect of paper saving as well as the operability and usability of a printing device means by the user.

That is, the printing device means (printer, multi-function printer, etc.) connected to the computer means is used to allow the user to easily select and output the new paper, the scrap paper (green-paper), the special paper, etc. according to the use of the printed matter that the user wants to output, thereby maximizing the user's operability and convenience.

### BACKGROUND ART

A printing means, that is, a printer, has one or more paper trays so that the size or material of the paper can be distinguished and used, and a plurality of printing means can be connected to one computer or computing device using a network.

In the computer having one or more printers, the print command window provided on the computer has a selection window for selecting each printer, and the print matters are output to the printer selected in the selection window. In addition, if multiple paper trays are installed in the printer, the user selects each paper tray and then clicks the print button to execute the printing on the paper stored in the paper tray.

In the conventional printing process, that is, when the paper tray is installed in multiple stages in each printer and one or more printers, the user clicks on the print button of the program, if a print command is performed, it selects the printer to print on the activated print command window, sets the paper tray in the selected printer, sets the environment by storing the set information, and then, clicks on the print button formed on one side of the print command window to print on the desired paper tray of the desired printer.

More specifically, If the user wants to print a Korean document, for example, when the user clicks a print button on a computer screen, a basic print window appears, and when a set button that can know the information of the printer is clicked on the basic print window, the printer properties appear, and when the user clicks the automatically selected paper source menu in this window, tray 1, tray 2, etc. appear as submenus, and when printing with a scrap paper (green paper) in the tray 2, the user clicks the tray 2 to select it and clicks OK, and the basic print window appears again, and here, when the user clicks the print, so that the printing is done on the paper the user wants.

In the above example, as described above, when the Korean document is to be printed, the users have to click 5 times to print, and the printing methods in PowerPoint, PDF files, Chrome, etc. are also different, and the users have to click more than 7 times to select the paper tray they want to select, which takes unnecessary printing time and is inconvenient.

That is, in the conventional printing execution process, not only is it inconvenient for users to use, but there is also the problem of making it difficult to easily select the paper tray stored for each type of paper.

In other words, due to user errors and malfunctions, there is an occurrence of a case in which the paper is left out, or output to a printing paper that is not intended for the purpose.

The paper production begins with cutting down trees.

If it converts the amount of paper used in Koran in a year into wood, 240 million trees are cut down.

Also, 10L of water is consumed to make an A4-paper sheet mainly used for printing paper, and 2.8g of carbon is discharged.

The copy paper market in Korea is worth 300 billion won per year.

Based on the feedback from users who are using the present invention and a survey result indicating that copy paper can be saved by more than 35%, it is estimated that an annual budget of 100 billion won can be saved.

In particular, when the present invention is applied, the government's Green New Deal policy can be implemented by saving 5.2 million tons of water, reducing 152,000 tons of carbon, saving 1.44 million trees, saving 580 million kW of electricity, and reducing waste generation by 52,000 tons.

Therefore, the present invention is intended to provide a user-friendly output device for each printer paper tray that can prevent overuse of printing paper, thereby saving the paper, and solving fundamental environmental problems.

In particular, the present invention provides an output device for each printer paper tray, which can exhibit excellent effects when applied to a printer or copier having two or more paper trays installed.

According to the application of the present invention, if the users click the print button in the basic print window for any document or file format, the paper tray selection window is activated where they can immediately select paper, and they can intuitively click the desired paper tray to print the desired printout with one click.

That is, in order to reuse the discarded scrap paper (green paper) in all office environments, a scrap paper storage box is provided and collected, and when the scrap paper (green paper) needs to be used, the scrap paper (green paper) is taken from the scrap paper storage box, the new paper is removed, the scrap paper (green paper) is inserted therein, and then, the new paper is inserted again after printing, which is an unnecessary action and the inconvenience of having to click 5 or 7 times or more as mentioned above, so that it can prevent throwing away the scrap paper (green paper) collected in the scrap paper storage box.

Accordingly, as a prior art regarding the output device for each printer paper tray, Korean Patent Publication No. 1992-0009347 entitled “paper tray control system” (hereinafter, referred to as ‘Patent Literature 1’) comprises:
a base machine; a main control means for controlling the base machine, a paper stocking control device attachable to the base machine and for switching both the duplex mode and the compositing mode, a tray control means for controlling the paper stocking control device of the paper tray means, and a communication line means for connecting the tray control means and the main control means, wherein the paper tray means is controlled according to the command of the main control means.

As another prior art, Korean Patent Registration No. 10-0412500 entitled “printer capable of saving paper and ink and a control method thereof” (hereinafter, referred to as ‘Patent Literature 2’) comprises:
an interface for receiving correction data of a printed document from a host, a printing unit for printing the correction data, and a control unit for controlling the printing unit to print the correction data received at the interface, and an input unit for selecting and inputting a partial printing option for partially printing the correction data, so that only a portion where a typo occurred can be corrected and designated, and data corrected by the partial printing option can be reprinted on the paper on which the typo occurred, thereby preventing waste of paper and ink, and efficiently enabling saving of paper and ink.

As described above, Patent Literature 1 and Patent Literature 2 relate to the printing device for outputting the output and the control system thereof, and the technical field of thereof is similar or identical to the technical field of the present invention, however, there is a difference in terms of the specific solution of the technical idea of the present invention.

That is, since there are differences between Patent Literature 1 and Patent Literature 2 and the present invention in the problem to be solved by the invention (object of the invention), a solution means (element) for solving it, and the effect exerted by solving the same thereby, the technical features thereof are different from each other.

### PATENT LITERATURE

Patent Literature 1: Korean Patent Publication No. 1992-0009347 (Oct. 15, 1992)

Patent Literature 2: Korean Patent Registration No. 10-0412500 (Dec. 12, 2003)

### DISCLOSURE

### Technical Problem

Accordingly, the present invention has been made in an effort to solve the above- mentioned conventional problems.

An object of the present invention is to provide an output device for each printer paper tray, which enables a user to easily select and output a printing paper according to the use of a work to be printed during a work printing operation by the user.

Another object of the present invention is to provide an output device for each printer paper tray, which allows the user to easily select the printing paper according to the purpose of the work to be printed or output, thereby preventing errors in selecting the printing paper and resulting paper overuse, saving paper, and strengthening the cornerstone for solving environmental problems.

### Technical Solution

According to one aspect of the present invention so as to accomplish these objects, there is provided to an output device for each printer paper tray, including:
a computer means that allows a user to create and edit a work;
a printing device means which is connected to the computer means and through which the user's work is printed and output; and
a printer tray setting means, which is formed in the computer means and that facilitates an operability and a usability of the printing device means by the user when the user prints the work through the printing device means, wherein when the user uses computer means to create and edit the work, and then prints the work through the printing device means, a paper tray selection window is activated due to the printer tray setting means, thereby maximizing the operability and usability of the printing device by the user.

At this time, the paper tray selection window includes:
a new paper tray selection module that allows the work to be outputted using the new paper according to the user's selection;
a green paper tray selection module that allows the work to be outputted using the scrap paper; and
a special paper tray selection module that allows the work to be outputted using the special paper other than the new paper and the scrap paper, thereby allowing the user to select the printing paper according to the purpose of the work to be outputted and easily printing it through the printing device.

In addition, the printer tray setting means includes:
a printing device means information checking unit for checking and setting information of the printing device means connected to the computer means; and
an UI environment setting unit for setting and changing an environment of the paper tray selection window which is activated by a display of the computer means during a work printing operation of the user using the printing device means,
wherein the printing device means information checking unit includes:
a printing device means driver selection module that identifies and selects driver information of the printing device means connected to the computer means;
a paper tray value acquisition module that can confirm and acquire a unique value of the paper tray of the printing device means selected through the printing device means driver selection module;
a unique value paper tray test module for checking the location of the paper tray formed in the print device means using the unique value of the paper tray confirmed and acquired from the paper tray value acquisition module;
a paper tray information setting storage module for inputting and setting the unique value of the paper tray in which the corresponding printing paper is to be stored according to a type of a pre-defined printing paper, on the basis of the location information of the paper tray confirmed through the unique value paper tray test module;
a paper tray information addition setting module for adding the type of the printing paper to the paper tray information setting storage module to add and set a unique value of the paper tray in which the added printing paper is stored;
a final printing paper test module for finally confirming whether a printing paper is selected and output from the paper tray according to information set and stored through the paper tray information setting storage module and the paper tray information addition setting module,
wherein the paper tray value acquisition module includes:
a new paper tray unique value acquisition element for acquiring a unique value of a paper tray to be printed with a new paper;
a scrap paper tray unique value acquisition element for acquiring a unique value of a paper tray to be printed with a scrap paper; and
a special paper tray unique value acquisition element for acquiring a unique value of the paper tray to be printed with special paper, so that the unique value of one or more paper trays formed in the printing device means can be acquired,
wherein the paper tray information setting storage module includes:
a new paper tray setting element that sets a new paper tray by inputting a unique value of the paper tray acquired from the new paper tray unique value acquisition element;
a scrap paper tray setting element that sets a scrap paper tray by inputting a unique value of the paper tray acquired from the scrap paper tray unique value acquisition element; and
a special paper tray setting element that sets a special paper tray by inputting a unique value of the paper tray acquired from the special paper tray unique value acquisition element, so that it is possible to easily set up the paper tray where the printing paper to be printed is stored according to the purpose of the work,
wherein the final printing paper test module includes:
a new paper test element that finally confirms and checks a print output on a new paper;
a scrap paper test element that finally confirms and checks a print output on a scrap paper; and
a special paper test element that finally confirms and checks a print output on a special paper, so that the user can easily operate and manage the print and output of the work by means of the printing device means connected to the computer means.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above with the configuration and operations, according to the present invention described above, there are following effects.
1. In the work printing operation, it is convenient for the user to select the paper tray in which the printing paper is stored.
2. Depending on the use of the work to be output, the user may easily select the printing paper to be output.
3. Depending on the use thereof, the printing paper to be printed and output can be selected by the user without error.
4. By promoting the accuracy of printing paper use, the abuse of the paper can be prevented to be saved.
5. In addition, when setting and printing by the user, the intuition and operability of a user experience (UX) and a user interface (UI) for an activated platform can be easily used by anyone (Good Efficacy).

This is a very effective invention that not only maximizes the ease of selecting the paper tray according to the purpose and use by the user (selection of the printing paper on which the work will be printed and output), but also solves the fundamental environmental problem by preventing the overuse of the printing paper and saving its use.

### BRIEF DESCRIPTION OF DRAWINGS

The above and other objects, features and advantages of the present invention will be more apparent from the following detailed description taken in conjunction with the accompanying drawings, in which:

FIG. 1 is a block diagram of an output device for a printer paper tray according to an embodiment of the present invention;

FIG. 2 is a conceptual view illustrating an output device for each printer paper tray according to an embodiment of the present invention;

FIG. 3 is a flow chart illustrating a mechanism of an output device for each printer paper tray according to an embodiment of the present invention;

FIG. 4 is a diagram illustrating an embodiment of a platform for a printing device means information search unit of a printer tray setting means among elements of an output device for each printer paper tray according to an embodiment of the present invention;

FIG. 5 is a view illustrating an embodiment of a platform for a UI environment setting unit of a printer tray setting means among elements of an output device for each printer paper tray according to an embodiment of the present invention; and

FIG. 6 is a view illustrating an embodiment of a platform for a paper tray selection window activated during printing and output operations, among elements of an output device for each printer paper tray according to an embodiment of the present invention.

### REFERENCE SIGNS LIST

1: Output device for each printer paper tray
100: Printer tray setting means
110: Printing device means information checking unit
111: Printing device means driver selection module
112: Paper tray value acquisition module
112a: New paper tray unique value acquisition element
112b: Scrap paper tray unique value acquisition element
112c: Special paper tray unique value acquisition element
113: Unique value paper tray test module
114: Paper tray information setting storage module
114a: New paper tray setting element
114b: Scrap paper tray setting element
114c: Special paper tray setting element
115: Paper tray information addition setting module
116: Final print paper test module
116a: New paper test element
116b: Scrap paper test element
116c: Special paper test element
117: Printing device means driver listing module
118: Printing device means driver information modification and deletion module
119: Printing device means driver information modification application termination module
118a: Printing device means driver deletion element
118b: Printing device means driver modification element
120: UI environment setting unit
121: New paper tray name change module
122: Scrap paper tray name change module
123: Special paper tray name change module
PC: Computer means
PR: Printing device means
SW: Paper tray selection window
SW1: New paper tray selection module
SW2: Green paper tray selection module
SW3: Special paper tray selection module

### BEST MODE

### Mode for Invention

Hereinafter, functions, configurations, and operations effects of an output device for each printer paper tray (1) according to the present invention will be described in detail with reference to the accompanying drawings.

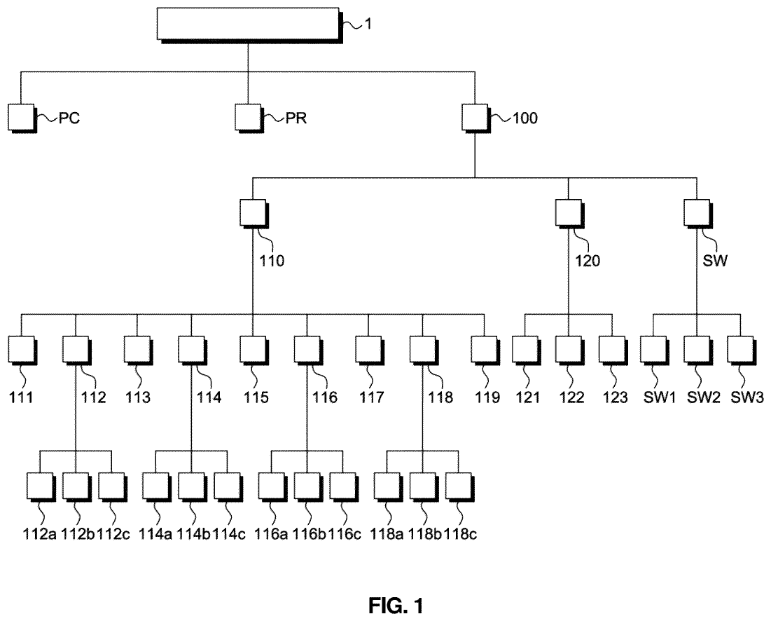

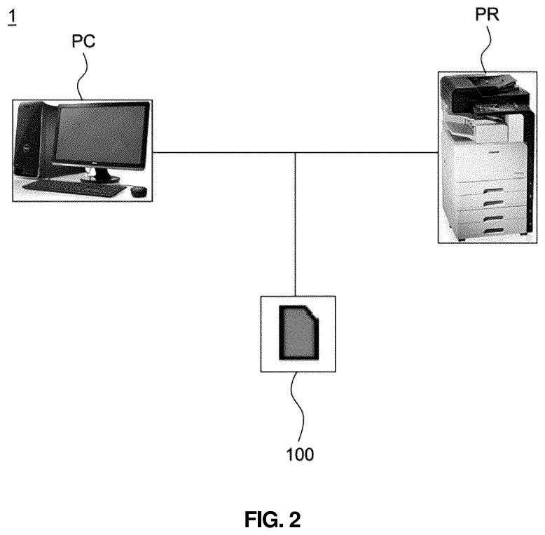

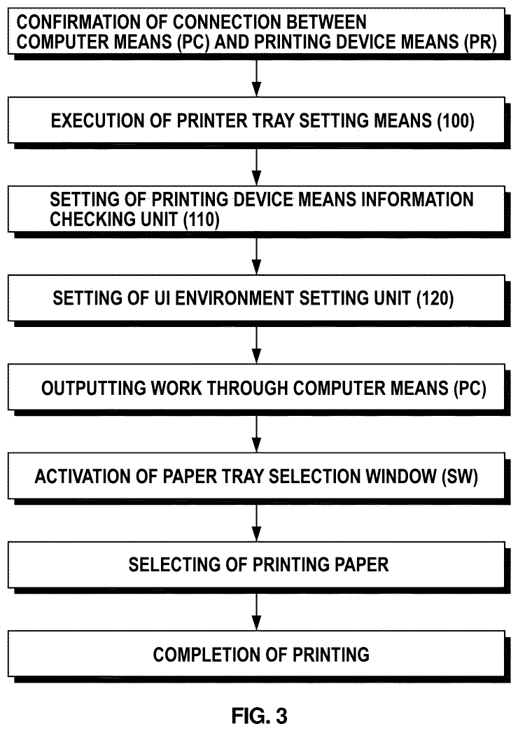

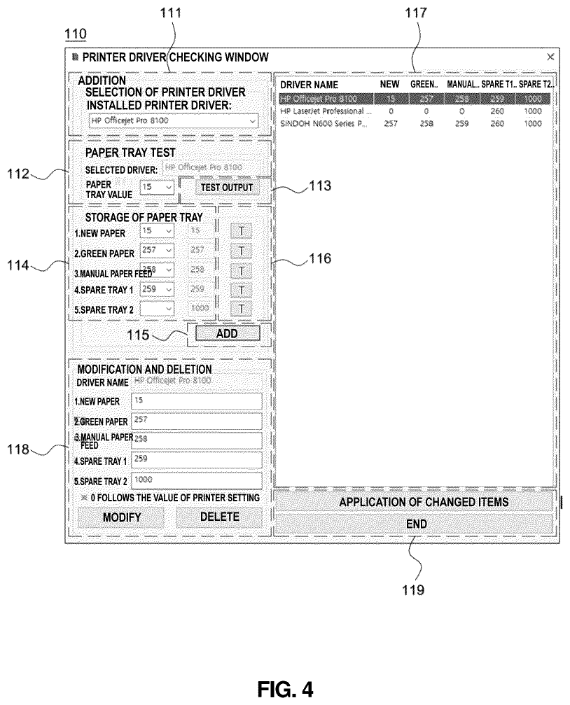

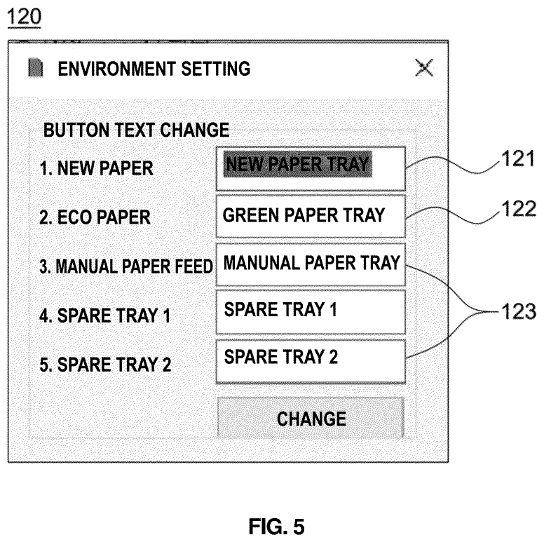

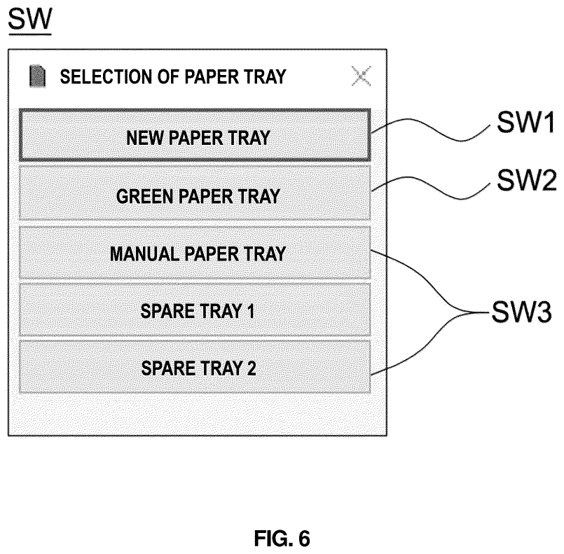

FIG. 1 is a block diagram of an output device for a printer paper tray according to an embodiment of the present invention; FIG. 2 is a conceptual view illustrating an output device for each printer paper tray according to an embodiment of the present invention; FIG. 3 is a flow chart illustrating a mechanism of an output device for each printer paper tray according to an embodiment of the present invention; FIG. 4 is a diagram illustrating an embodiment of a platform for a printing device means information search unit of a printer tray setting means among elements of an output device for each printer paper tray according to an embodiment of the present invention; FIG. 5 is a view illustrating an embodiment of a platform for a UI environment setting unit of a printer tray setting means among elements of an output device for each printer paper tray according to an embodiment of the present invention; and FIG. 6 is a view illustrating an embodiment of a platform for a paper tray selection window activated during printing and output operations, among elements of an output device for each printer paper tray according to an embodiment of the present invention.

As shown in FIG. 1 to FIG. 6, the output device (1) for each printer paper tray according to the present invention includes:
a computer means (PC), that allows a user to create and edit a work;
a printing device means (PR) which is connected to the computer means (PC) and through which the user's work is printed and output; and
a printer tray setting means (100), which is formed in the computer means (PC) and that facilitates the operability and usability of the printing device means (PR) by the user when the user prints the work through the printing device means (PR), wherein when the user uses computer means (PC) to create and edit the work, and then prints the work through the printing device means (PR), a paper tray selection window (SW) is activated due to the printer tray setting means (100), thereby maximizing the operability and usability of the printing device (PR) by the user.

That is, according to the output device (1) for each printer paper tray, by allowing the user to use the computer means (PC) to create, edit, and then print and output through the printing device means (PR) connected to the computer means (PC), it enables the user to easily select the printing paper suitably according to the use of the work to be output, thereby maximizing the operability and usability of the printing device (PR) by the user.

In other words, according to the output device (1) for each printer paper tray, when the user uses the computer means (PC) to create and edit the work and then, print and output the created work through the printing device means (PR), it allows the user to easily select and output the printing paper according to the purpose of the work through the paper tray selection window (SW) activated by the printer tray setting means (100) from the display of the computer means (PC).

According to an embodiment of the present invention, a configuration of the present invention will be described in more detail.

The computer means (PC) is a high-speed automatic calculator using electronic circuits, and is widely used for personal and office computers for numerical calculations, automatic control, data processing, office management, language or image information processing, etc.

The printing device means (PR) is an output device that prints the information processed and stored in the computer means (PC) in a form that can be viewed by a person using the printing paper.

As shown in FIG. 4 to FIG. 5, the printer tray setting means (100) includes:
a printing device means information checking unit (110) for checking and setting information of the printing device means (PR) connected to the computer means (PC); and
an UI environment setting unit (120) for setting and changing an environment of the paper tray selection window (SW) which is activated by a display of the computer means (PC) during a work printing operation of the user using the printing device means (PR),
wherein the printing device means information checking unit (110) includes:
a printing device means driver selection module (111) that identifies and selects driver information of the printing device means (PR) connected to the computer means (PC);
a paper tray value acquisition module (112) that can confirm and acquire a unique value of the paper tray of the printing device means (PR) selected through the printing device means driver selection module (111);
a unique value paper tray test module (113) for checking the location of the paper tray formed in the print device means (PR) using the unique value of the paper tray confirmed and acquired from the paper tray value acquisition module (112);
a paper tray information setting storage module (114) for inputting and setting the unique value of the paper tray in which the corresponding printing paper is to be stored according to a type of a pre-defined printing paper, on the basis of the location information of the paper tray confirmed through the unique value paper tray test module (113);
a paper tray information addition setting module (115) for adding the type of the printing paper to the paper tray information setting storage module (114) to add and set a unique value of the paper tray in which the added printing paper is stored; and
a final printing paper test module (116) for finally confirming whether a printing paper is selected and output from the paper tray according to information set and stored through the paper tray information setting storage module (114) and the paper tray information addition setting module (115),
wherein the paper tray value acquisition module (112) includes:
a new paper tray unique value acquisition element (112a) for acquiring a unique value of a paper tray to be printed with a new paper;
a scrap paper tray unique value acquisition element (112b) for acquiring a unique value of a paper tray to be printed with a scrap paper; and
a special paper tray unique value acquisition element (112c) for acquiring a unique value of the paper tray to be printed with special paper, so that the unique value of one or more paper trays formed in the printing device means (PR) can be acquired,
wherein the paper tray information setting storage module (114) includes:
a new paper tray setting element (114a) that sets a new paper tray by inputting a unique value of the paper tray acquired from the new paper tray unique value acquisition element (112a);
a scrap paper tray setting element (114b) that sets a scrap paper tray by inputting a unique value of the paper tray acquired from the scrap paper tray unique value acquisition element (112b); and
a special paper tray setting element (114c) that sets a special paper tray by inputting a unique value of the paper tray acquired from the special paper tray unique value acquisition element (112c), so that it is possible to easily set up the paper tray where the printing paper to be printed is stored according to the purpose of the work,
wherein the final printing paper test module (116) includes:
a new paper test element (116a) that finally confirms and checks a print output on a new paper;
a scrap paper test element (116b) that finally confirms and checks a print output on a scrap paper; and
a special paper test element (116c) that finally confirms and checks a print output on a special paper, so that the user can easily operate and manage the print and output of the work by means of the printing device means (PR) connected to the computer means (PC).

At this time, the printing device means information checking unit (110) further includes:
a printing device means driver listing module (117) which lists and aligns drivers of the printing device means (PR) for which all settings have been completed, and which causes driver information of the printing device means (PR) set by the user to be immediately and visually checked;
a printing device means driver information modification and deletion module (118) for loading driver information of one or more printing device means (PR) aligned with the printing device means driver listing module (117) to modify and delete the set information; and
a printing device means driver information modification application termination module (119) that stores the driver information of the printing device means (PR) modified, deleted, and changed from the printing device means driver information modification and deletion module (118), and terminates the printing device means information checking unit (110), so that it becomes easier for the user to manage a printing environment of the printing device means (PR),
wherein the printing device means driver information modification and deletion module (118) includes:
a printing device means driver deletion element (118a) for deleting driver information of the printing device means (PR) stored in the printing device means driver listing module (117); and
a printing device means driver modification element (118b) that allows the user to modify the driver information of the selected printing device means (PR) selected by the user, among the driver information of the printing device means (PR) stored in the printing device means driver listing module (117), thereby modifying and deleting the information of the printing device means (PR) stored by the user.

That is, through the printing device means driver modification element (118b), it is possible to modify, change, or delete the unique value of the paper tray set and stored by the user.

Meanwhile, the UI environment setting unit (120), which is capable of setting and managing the environment of a paper tray selection window (SW) activated in a printing operation to allow the user to easily select a printing paper corresponding to the work, and which sets, modifies, and changes the environment of the paper tray selection window (SW) activated by the display of the computer means (PC) during a work printing operation of the user using the printing device means (PR), includes:
a new paper tray name change module (121) for changing and storing a name of the paper tray formed in the printing device means (PR), in which a new paper is stored, which is output to the paper tray selection window (SW);
a scrap paper tray name change module (122) for changing and storing a name of a paper tray formed in the printing device means (PR), in which a scrap paper is stored, which is output to the paper tray selection window (SW); and
a special paper tray name change module (123) for changing and storing a name of a paper tray formed in the printing device means (PR), in which a special paper is stored, which is output to the paper tray selection window (SW), so that the user can easily change and store the name of the paper tray according to the printing paper that is output to the paper tray selection window (SW) activated during the printing operation.

As described above, the paper tray selection window (SW) set by the UI environment setting unit (120), which is activated when the user prints, as shown in FIG. 6, includes:
a new paper tray selection module (SW1) that allows the work to be outputted using the new paper according to the user's selection;
a green paper tray selection module (SW2) that allows the work to be outputted using the scrap paper; and
a special paper tray selection module (SW3) that allows the work to be outputted using the special paper other than the new paper and the scrap paper, thereby allowing the user to select the printing paper according to the purpose of the work to be outputted and easily printing it through the printing device (PR), the ease of selecting printing paper for users is maximized, and by preventing overuse of printing paper and printing errors resulting from this, it becomes a cornerstone for solving the root of environmental problems.

This makes it possible to maximize the ease of selection of the printing paper for the user, as well as prevent the abuse of the printing paper and the output of the printing paper, thereby resolving the root of the environmental problem.

FIG. 3 is a flow chart illustrating a mechanism of an output device (1) for each printer paper tray according to an embodiment of the present invention.

More specifically, first, the user confirms the connection of the computer means (PC), which will create and edit the work, and the printing device means (PR) (it checks whether printing is working properly using the conventional printing method).

Also, it executes the printer tray setting means (100) in a computer means (PC).

It checks and obtains the information of one or more printing device means (PR) connected to the computer means (PC) through the printing device means information checking unit (110) of the executed printer tray setting means (100) and selects the printing device means (PR) to be registered in the printer tray setting means (100).

In addition, it checks and obtains the unique value for each paper tray of the selected printing device means (PR) and checks the location of the paper tray corresponding to the checked and obtained unique value for the printing device means (PR).

That is, the location of the paper tray for storing the new paper, the scrap paper, and the special paper is checked.

Thereafter, the user determines and sets the paper tray to be used as the new paper, the scrap paper, and the special paper.

Through the UI environment setting unit (120), it checks and sets the environment of the paper tray selection window (SW) to be activated during the printing operation (the user may change the name of the paper tray in which the paper, the scrap paper, and the special paper are stored).

As described above, after the setting of the printer tray setting means (100) is completed, the user prints the work created or edited using the computer means (PC).

When the work is output, the paper tray selection window (SW) is activated.

Through the activated paper tray selection window (SW), the user easily selects the printing paper according to the purpose of the work to be printed, so that the work is printed and output through the printing device means (PR).

It will be apparent to those skilled in the art that the present invention is not limited to the disclosed embodiments, but may be variously modified and modified without departing from the spirit and scope of the present invention.

Therefore, since the embodiments of the present invention may be implemented in various forms without departing from the technical spirit or the main feature, embodiments of the present invention are not limited to a simple example in all respects, and may be variously modified and implemented.

### Industrial Applicability

The present invention relates to an output device for each printer paper tray, and can be applied to contribute to the advancement of various industrial fields, such as the manufacturing and sales industries that manufacture the same, particularly the software-related industries that facilitate the use of printing devices, and the environment-related industries that preserve nature by preventing the overuse of paper.

What is claimed is:

1. An output device for each printer paper tray, comprising:
a computer means (PC), that allows a user to create and edit a work;
a printing device means (PR) which is connected to the computer means (PC) and through which the user's work is printed and output; and
a printer tray setting means (100), which is formed in the computer means (PC) and that facilitates an operability and a usability of the printing device means (PR) by the user when the user prints the work through the printing device means (PR), wherein when the user uses computer means (PC) to create and edit the work, and then prints the work through the printing device means (PR), a paper tray selection window (SW) is activated due to the printer tray setting means (100), thereby maximizing the operability and usability of the printing device (PR) by the user,
wherein the paper tray selection window (SW) includes:
a new paper tray selection module (SW1) that allows the work to be outputted using the new paper according to the user's selection;
a green paper tray selection module (SW2) that allows the work to be outputted using the scrap paper; and
a special paper tray selection module (SW3) that allows the work to be outputted using the special paper other than the new paper and the scrap paper, thereby allowing the user to select the printing paper according to the purpose of the work to be outputted and easily printing it through the printing device (PR),
wherein the printer tray setting means (100) includes:
a printing device means information checking unit (110) for checking and setting information of the printing device means (PR) connected to the computer means (PC); and
an UI environment setting unit (120) for setting and changing an environment of the paper tray selection window (SW) which is activated by a display of the computer means (PC) during a work printing operation of the user using the printing device means (PR),
wherein the printing device means information checking unit (110) includes:
a printing device means driver selection module (111) that identifies and selects driver information of the printing device means (PR) connected to the computer means (PC);
a paper tray value acquisition module (112) that can confirm and acquire a unique value of the paper tray of the printing device means (PR) selected through the printing device means driver selection module (111);
a unique value paper tray test module (113) for checking the location of the paper tray formed in the print device means (PR) using the unique value of the paper tray confirmed and acquired from the paper tray value acquisition module (112);
a paper tray information setting storage module (114) for inputting and setting the unique value of the paper tray in which the corresponding printing paper is to be stored according to a type of a pre-defined printing paper, on the basis of the location information of the paper tray confirmed through the unique value paper tray test module (113);
a paper tray information addition setting module (115) for adding the type of the printing paper to the paper tray information setting storage module (114) to add and set a unique value of the paper tray in which the added printing paper is stored; and
a final printing paper test module (116) for finally confirming whether a printing paper is selected and output from the paper tray according to information set and stored through the paper tray information setting storage module (114) and the paper tray information addition setting module (115),
wherein the paper tray value acquisition module (112) includes:
a new paper tray unique value acquisition element (112a) for acquiring a unique value of a paper tray to be printed with a new paper;
a scrap paper tray unique value acquisition element (112b) for acquiring a unique value of a paper tray to be printed with a scrap paper; and
a special paper tray unique value acquisition element (112c) for acquiring a unique value of the paper tray to be printed with special paper, so that the unique value of one or more paper trays formed in the printing device means (PR) can be acquired,
wherein the paper tray information setting storage module (114) includes:
a new paper tray setting element (114a) that sets a new paper tray by inputting a unique value of the paper tray acquired from the new paper tray unique value acquisition element (112a);
a scrap paper tray setting element (114b) that sets a scrap paper tray by inputting a unique value of the paper tray acquired from the scrap paper tray unique value acquisition element (112b); and
a special paper tray setting element (114c) that sets a special paper tray by inputting a unique value of the paper tray acquired from the special paper tray unique value acquisition element (112c), so that it is possible to easily set up the paper tray where the printing paper to be printed is stored according to the purpose of the work,
wherein the final printing paper test module (116) includes:
a new paper test element (116a) that finally confirms and checks a print output on a new paper;
a scrap paper test element (116b) that finally confirms and checks a print output on a scrap paper; and
a special paper test element (116c) that finally confirms and checks a print output on a special paper, so that the user can easily operate and manage the print and output of the work by means of the printing device means (PR) connected to the computer means (PC),
wherein the printing device means information checking unit (110) further includes:
a printing device means driver listing module (117) which lists and aligns drivers of the printing device means (PR) for which all settings have been completed, and which causes driver information of the printing device means (PR) set by the user to be immediately and visually checked;
a printing device means driver information modification and deletion module (118) for loading driver information of one or more printing device means (PR) aligned with the printing device means driver listing module (117) to modify and delete the set information; and
a printing device means driver information modification application termination module (119) that stores the driver information of the printing device means (PR) modified, deleted, and changed from the printing device means driver information modification and deletion module (118), and terminates the printing device means information checking unit (110), so that it becomes easier for the user to manage a printing environment of the printing device means (PR),
wherein the printing device means driver information modification and deletion module (118) includes:
a printing device means driver deletion element (118a) for deleting driver information of the printing device means (PR) stored in the printing device means driver listing module (117); and
a printing device means driver modification element (118b) that allows the user to modify the driver information of the selected printing device means (PR) selected by the user, among the driver information of the printing device means (PR) stored in the printing device means driver listing module (117), thereby modifying and deleting the information of the printing device means (PR) stored by the user, so that, through the printing device means driver modification element (118b), it is possible to modify, change, or delete the unique value of the paper tray set and stored by the user,
wherein the UI environment setting unit (120), which is capable of setting and managing an environment of the paper tray selection window (SW) activated in a printing operation to allow the user to easily select a printing paper corresponding to the work, and which sets, and changes the environment of the paper tray selection window (SW) activated by the display of the computer means (PC) during a work printing operation of the user using the printing device means (PR), includes:
a new paper tray name change module (121) for changing and storing a name of the paper tray formed in the printing device means (PR), in which a new paper is stored, which is output to the paper tray selection window (SW);
a scrap paper tray name change module (122) for changing and storing a name of a paper tray formed in the printing device means (PR), in which a scrap paper is stored, which is output to the paper tray selection window (SW); and
a special paper tray name change module (123) for changing and storing a name of a paper tray formed in the printing device means (PR), in which a special paper is stored, which is output to the paper tray selection window (SW), so that the user can easily change and store the name of the paper tray according to the printing paper that is output to the paper tray selection window (SW) activated during the printing operation.
